(19) United States
(12) Patent Application Publication
(10) Pub. No.: US 2008/0247352 A1
(43) Pub. Date: Oct. 9, 2008

(54) Determination By a Communication Terminal of the Propagation Time of a Reference Signal Coming From a Communications Management Equipment

(75) Inventor: Beatrice Martin, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL, Paris (FR)

(21) Appl. No.: 11/569,237

(22) PCT Filed: Apr. 29, 2005
(86) PCT No.: PCT/FR05/50290

§ 371 Date: Jan. 25, 2008

(30) Foreign Application Priority Data
May 17, 2004 (FR) 0450953

(51) Int. Cl. H04B 7/208; H04B 7/185

(52) U.S. Cl. 370/319; 370/316

(57) ABSTRACT

A communication network including at least one piece of communication management equipment (SG) having a management component (MG) in charge of generating reference signals to be transmitted in a signaling channel to communication terminals (UE) connected thereto, and provided, along with each of the terminals (LIE), with an internal time reference which is defined in relation to a time set of a satellite positioning system (CS). The management component (MG) is also configured in such a way as to be able to generate a message including information representing the time of transmission of a reference signal in relation to the time set with a view to the transmission thereof to the terminals (UE) in a signaling channel.

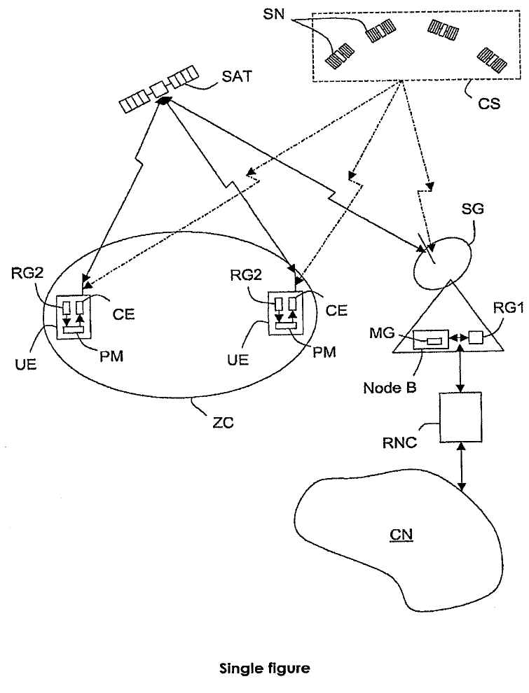

The invention concerns the field of communications networks in which it is not possible to know accurately the propagation time of a signal, and more particularly the management of communications within such networks.

Certain communications networks, and in particular those known as “random access” networks, require fine synchronization of sending by communication terminals that are attached to their communications management equipments, such as base stations.

To this end, the networks broadcast, generally periodically, via their communications management equipments, reference signals (usually called “pilot beacon” signals) that represent the clock that the terminals that are attached to them must use as an internal time reference for synchronizing their sending relative to a predetermined model that can be configured and is generally broadcast periodically. In other words, when a terminal receives a pilot beacon signal it locks its internal clock to the clock defined by that pilot beacon signal.

Now, the time taken by a pilot beacon signal to reach a terminal varies either as a function of the position of said terminal relative to the coverage area of the base station to which it is attached (in the case of a radio network) or as a function of the characteristics of the transmission medium providing the connection between said terminal and the communications management equipment to which it is attached (in the case of a heterogeneous cable network).

This is in particular the case of satellite radio networks in which the time of reception of the pilot beacon signal depends on the position of the terminal on either side of what the person skilled in the art calls the “spot”.

This is also the case of cellular radio networks using terrestrial and/or satellite repeaters.

It is further the case of cable networks using heterogeneous transmission media and/or providing both local and long-distance (for example transatlantic) connections, which induce significantly different propagation times.

In the situations cited above, each terminal, attached to a communications management equipment, sending at times defined by the model associated with said equipment and referenced to the time of reception of the pilot beacon frequency, said equipment therefore receives the signals transmitted by the terminals that are attached to it at virtually any time and not at precise times, with the result that the synchronization of the terminal is not effective. More precisely, because of the time differences between the internal time references of the various terminals, the receive time windows of the communications management equipment, locked to its own internal time reference and of the same width as that of the access slots, are no longer suitable.

To attempt to remedy this drawback certain solutions have been proposed.

Accordingly, in cellular networks of TDMA type, such as GSM networks, it has been proposed to determine for each terminal having effected a first access to the network a timing compensation (or timing advance) to be applied to the sending times on subsequent access. Each timing compensation is determined at the level of a base station. It corresponds to the round trip propagation time between the base station and the terminal concerned in the internal time frame of reference of the base station. The timing compensation is transmitted to the terminal concerned via a signaling channel, in order for it to apply it immediately to its sending system.

The principal drawback of this solution resides in the fact that it monopolizes resources of each base station for the calculation and transmission of the time compensations to the terminals attached to it that are involved in calls. Moreover, this solution is not applicable to the first access to a network from a terminal.

In cellular networks of TDMA type, such as GMR (for example Thuraya) networks, it has been proposed to increase the guard time between the network access slots defined by the model that is broadcast. The principal drawback of this solution resides in the fact that it increases the guard time to the detriment of the number of access slots available (only four remain available of the original eight). Once a terminal has effected its first access, the determination and the application of the time compensation, as described hereinabove, is effected.

In satellite networks it has been proposed to broadcast to the terminals, on a common channel, information representative of the ephemeredes of their satellite. Those ephemeredes are then used by each terminal to determine the time compensation that it must apply to its sending system.

For example, in a CDMA network of S-UMTS type, to effect a first access to the network the terminals must first listen to information transmitted on common signaling channels called the “pilot”, “SCH” and “BCH” channels and then wait to receive the ephemeredes broadcast by a cell broadcast service on a common channel (called the FACH) reserved for broadcasting data. One such solution is described in particular in the patent document EP 1 296 467.

The drawback of this solution resides in the fact that it requires adaptation of the communication terminals, the radio interface and the standard procedures for access to the network used by the terminals. No solution known in the art proving entirely satisfactory, an object of the invention is therefore to improve upon the situation.

To this end it proposes a method of calculating the propagation time of a reference signal between a communications management equipment of a communications network (where applicable a random access network) and communication terminals attached to the equipment, the equipment and the terminals each having an internal time reference defined relative to the time reference of a satellite positioning network (or a GNSS network, for example a GPS (Global Positioning System) network) and supplied by a positioning receiver. It may be noted that the time reference does not necessarily come directly from the satellites of the GNSS network; in fact, it may come from terrestrial relays.

This method is characterized in that it consists in:
sending to the terminals, by means of the equipment and on at least one (common or dedicated) signaling channel, a reference signal and an associated message including information representative of the time of sending of the reference signal relative to the time reference of the GNSS network,
then, when a terminal receives the reference signal and the message, time stamping the reception of the message so that the terminal can determine a time difference between the time of sending and the time of receiving the message and deduce therefrom the propagation time of the associated reference signal.
For example, when the reference signal defines a reference (for example a pilot beacon signal) for the temporal synchronization of the terminals relative to a model (or map) defining authorized access slots to the network, there is deduced from the propagation time, at the level of the terminal, the time difference representative of the round trip propagation time of a signal between the equipment and the terminal concerned, then this difference is applied to the model so as to lock the sending system of the terminal to the shifted model with a view to the transmission of a request for access to the network to the communications management equipment in one of the authorized access slots.

The transmission of the reference signal and the associated message may be effected on the same signaling channel (for example on the common channel BCH in the case of a network of CDMA type) or on separate signaling channels.

The invention also proposes a communications management equipment for a communications network (where applicable a random access network), comprising management means adapted to generate reference signals to be transmitted, on a (common or dedicated) signaling channel, to communication terminals attached to it, and having, like each of the terminals, an internal time reference defined relative to the time reference of a satellite positioning network (or GNSS network) and supplied by a GNSS receiver it includes or to which it is coupled.

This equipment is characterized in that the management means are further adapted to generate a message including information representative of the time of sending a reference signal relative to the time reference to the GNSS network with a view to its transmission to the terminals on a signaling channel.

The communications management equipment may generate each reference signal and the associated message so that they are transmitted on the same signaling channel or on two separate signaling channels.

The invention further proposes a communication terminal for a communications network (where applicable a random access network) including at least one communications management equipment of the type described hereinabove.

This communication terminal is characterized in that it comprises:
receiving means adapted to define, from signals coming from a satellite positioning network (or GNSS network), an internal time reference relative to the time reference of the GNSS network, and
processing means adapted, on reception of a reference signal and an associated message including information representative of the time of sending the reference signal relative to the time reference of the GNSS network transmitted by the communications management equipment to which their terminal is attached on at least one (common or dedicated) signaling channel, to time stamp the reception of the message and then to determine the time difference between the time of sending and the time of receiving the message so as to deduce from this time difference the propagation time of the reference signal associated with the message.

When the reference signal defines a reference for the time synchronization of the terminals relative to a model defining authorized access slots to the network, the processing means of a terminal may be adapted to deduce from the propagation time that they have determined a time shift representative of the round trip propagation time of a signal between the equipment and the terminal concerned and then to apply that shift to the model. In this case the communication terminal comprises a sending system adapted to be synchronized to the shifted model to transmit a network access request to the communications management equipment in one of the authorized access slots.

The invention is particularly well adapted, although not exclusively so, to random access communications networks chosen from FDMA, TDMA and CDMA networks, and more particularly those of W-CDMA, satellite (or IS-95) or terrestrial CDMA 2000, TTA, CCSA, (S-)UMTS, GMR, GSM and (S-)GSM/GPRS type, as well as those used for optical communications via optical fibers. However, it generally concerns all communications networks in which it is not possible to know accurately the propagation time of a signal, and in particular certain cable communications networks, for example those using electrical lines, and Internet Protocol (IP) networks.

Other characteristics and advantages of the invention will become apparent on examining the following detailed description and the appended drawing, in which the single FIGURE illustrates schematically one embodiment of a portion of a satellite communications network comprising satellite communications management equipment, of “gateway” type, and communication terminals, all coupled to a satellite positioning network.

The appended drawing constitute part of the description of the invention as well as contributing to the definition of the invention, if necessary.

An object of the invention is to enable the determination of the propagation time of signals by communication terminals attached to a communications network, where applicable a random access network.

Here “communication terminal” means any network equipment capable of exchanging data in the form of signals, either with another equipment, via their attachment network(s), or with its own attachment network. This could therefore mean, for example, user equipments, such as fixed or portable computers, fixed or portable telephones, or personal digital assistants (or PDA), or servers.

It is considered hereinafter, by way of illustrative example, that the communications network is a random access network, such as a CDMA satellite network of 3G type, for example an S-UMTS network, operating in frequency division duplex (FDD) mode or time division duplex (TDD) mode.

However, the invention is not limited to this type of network alone. In fact it concerns all communications networks that communication terminals can access using a random access procedure, relying for example on the sending of a preamble (or access request) during access time slots, and wherein there exists a wide spread (or divergence) of the propagation times of the signals between a communications management equipment and the communication terminals that are attached to it. Accordingly, the invention concerns in particular random access communications networks that include radio repeaters or relays, where appropriate of satellite type, for example FDMA, W-CDMA, satellite (or IS-95) or terrestrial CDMA 2000, TTA, CCSA, GMR, GSM and S-GSM/GPRS networks. However, the invention concerns equally cable networks using heterogeneous transmission media and/or providing both local and long-distance (for example transatlantic) connections, for example certain optical networks using optical fibers, with or without relays, and certain networks using electrical lines as the communication medium. It further concerns Internet Protocol (IP) networks.

Furthermore, it is considered hereinafter, by way of illustrative example, that the communication terminals are user equipments (UE) of mobile telephone type attached to the S-UMTS network.

As shown in the single FIGURE, a satellite access UMTS (S-UMTS) network can, very broadly speaking but nevertheless in sufficient detail for an understanding of the invention, be regarded as a core network (CN) coupled to a satellite access network.

The satellite access network includes first of all at least one communications management equipment, represented here in the form of a satellite base station (or gateway) SG connected to the core network CN by an RNC (radio network controller) node and at least one telecommunications satellite SAT enabling the exchange of data by radio between the gateway SG and user equipments UE (here mobile telephones) equipped with a satellite transceiver.

The satellite link constitutes a satellite interface. Moreover, the RNC provides both service and control. It is therefore referred to as a controlling and serving RNC.

The gateway SG incorporates a Node B (or base station) of the S-UMTS network responsible for processing the signal and in particular for managing requests for access to said S-UMTS network. The Node B is additionally associated with one or more cells each covering a radio area in which one or more user equipments UE may be located. The cell or cells of a Node B are included in the coverage area ZC of the satellite SAT that is associated with the gateway SG that incorporates it (here a cell corresponds to a satellite spot).

Moreover, the gateway SG comprises a satellite positioning receiver RG1 responsible for analyzing the signals supplied by a satellite positioning network (shown in the figure by its constellation CS of satellites SN). The satellite positioning network is a GNSS (Global Navigation Satellite System) network, for example the GPS network, the GLONASS network, or the future GALILEO network. It may be noted that the signals providing the time reference do not necessarily come directly from the satellites of the GNSS network; they may in fact come from terrestrial relays.

The GNSS receiver RG1 is responsible in particular for determining, from signals received from the GNSS network, the current time in the GNSS network, called the GNSS time (or system time), in order for the Node B to lock its internal clock to this GNSS time. Accordingly, the Node B has an internal time reference defined relative to the time reference of the GNSS network.

This internal time reference enables a management module MG of the Node B to generate reference signals, here defining what the person skilled in the art refers to as a pilot beacon signal, intended to be transmitted by the gateway SG, via the satellite SAT, to the user equipments UE that are situated in the coverage area ZC of said satellite SAT. In the example described, the reference signals are transmitted in broadcast mode on a common signaling channel. It is important to note that in the example network described, as in all other types of network, this transmission may be effected on dedicated signaling channels.

The Node B is also responsible for generating messages including a model (or map) defining (time) access slots during which the user equipments UE that are attached to it are authorized to send network access requests (or preambles). These models can generally be configured and are broadcast periodically to the user equipments UE by their gateway SG, via the satellite SAT and on a common signaling channel. For example, in a slotted ALOHA type access network, the width of an access slot is equal to 5120 chips (which corresponds to 1.3 ms).

In an S-UMTS network (among others), the access slot model is used by the user equipments UE that are attached to a Node B to determine the times (slots) during which they are authorized to send signals to the gateways SG that includes said Node B, in particular at the time of each first access to the network.

In fact, when a user equipment UE requires to communicate a message containing data, it must beforehand, at the time of its first access to the network, transmit an access request (or preamble) to its gateway SG. To do this, the user equipment UE generates a preamble accompanied by a signature which, in the case of slotted ALOHA type access, extends over a duration of N chips, for example N=4096 chips. In the case of an S-UMTS network, the signature is chosen at random from 16 signatures.

The user equipment UE then sends the preamble, in the form of radio signals, to the satellite SAT that covers the cell in which it is situated, using a dedicated random access channel RACH and in one of the authorized access time slots. The satellite SAT then transmits the signed preamble to the gateway SG, which communicates it to its Node B in order for it to initiate a preamble acknowledgement procedure. The message which is associated with a transmitted preamble can be sent by the user equipment UE only on condition that said preamble has been acknowledged by the Node B.

As indicated hereinabove, a preamble can be transmitted only during one of the authorized access slots defined by the received model. Now, this model being used by all the user equipments UE situated in the same cell (or coverage area ZC), the sending systems CE of those user equipments must be synchronized or locked to the same time reference, i.e. that of their Node B.

In a standard S-UMTS network, it is the reference (pilot beacon) signals that enable the user equipments UE to define their internal time reference to which their sending system CE is locked. If the propagation time of the reference signal between the Node B and the user equipments UE attached to it is not the same for all the user equipments UE, their sending systems are locked to different time references (shifted relative to each other), with the result that sending by the user equipments UE cannot be synchronized.

To solve this problem, the invention proposes first of all to equip each user equipment UE with a GNSS receiver RG2 responsible, like the GNSS receiver RG1 of the gateway SG, for analyzing the signals transmitted by the GNSS network CS to determine the GNSS time (or system time) in order for its sending system CE to be able to lock onto it. Accordingly, the user equipment UE has an internal time reference defined relative to the time reference of the GNSS network.

The invention also proposes to adapt the management module MG that each Node B of the S-UMTS network comprises so that each time it generates a reference (or pilot beacon) signal it also generates an associated message including information representative of the time of sending that reference signal relative to the time reference of the GNSS network to which its internal time reference is locked (thanks to the GNSS receiver RG1).

Each reference (or pilot beacon) signal and the associated message are then communicated by the Node B to the gateway SG in order for it to transmit them to the user equipments UE on at least one common signaling channel.

In the case of an S-UMTS network, it is preferable to transmit each reference (or pilot beacon) signal and the associated message on a single common signaling channel. For example, there may be used the channel BCH that is already used by the Node B and the RNC to transmit to the user equipments UE that are attached to it information on the GNSS network, for example the ephemeredes. Moreover, the S-UMTS standard requiring that the user equipments UE listen to the various signaling channels Pilot, SCH and BCH before initiating a network access request, it is therefore not necessary to modify the radio interface or the standard network access procedures implemented by the user equipments.

It is preferably the Node B that generates blocks of information (here of BCH type) constituting each reference signal and the associated message comprising the sending time. In CDMA, a sending time accuracy of the order of one chip (which is equivalent to 260 ns) is sufficient for the UMTS (W-CDMA) application. This accuracy in particular reduces interference, including on the random access channel.

However, transmitting each reference signal and the associated message on two different common signaling channels may be envisaged.

In order for the user equipments UE to be able to use the sending time contained in a message associated with a reference (pilot beacon) signal, the invention proposes to equip them with a processing module PM. According to the invention, this processing module PM is responsible for listening to the signaling (for example BCH) channel on which the messages associated with the reference signals are transmitted, in order to detect each message and to time stamp its reception relative to the GNSS time, supplied by the GNSS receiver GR2 and used to lock the sending system CE.

When the processing module PM is in possession of the sending time contained in a message and the time of reception of said message, it determines the time difference between those two times, and then deduces from that time difference (by simple subtraction) the (so-called “propagation”) time taken by the reference signal associated with the message to reach its user equipment UE.

The processing module PM is also responsible for deducing the time shift that must be applied to the model (here the access slot model) in order to take account of the round trip propagation time of the reference signal. To do this, it multiplies by 2 the value of the propagation time that it has just deduced, since the latter corresponds only to the outward leg (from the gateway SG to the user equipment UE). The processing module PM then applies the time shift to the access slot model.

The sending system CE then has only to synchronize (or lock) to the model shifted by the processing module PM in order to transmit a network access request to its Node B in one of the authorized access slots of said model and in accordance with the procedure described previously.

The sending systems of the user equipments attached to the same cell (or coverage area ZC) from now on being locked to the same time reference (the GNSS time), and the latter also constituting the time reference of the Node B, sending by the user equipments is therefore synchronized (here temporally) relative to each other. This greatly facilitates communications between the Node B and the user equipments attached to it, and in particular the access request (or preamble) acknowledgement procedures.

The processing module PM of a communication user equipment UE according to the invention and the management module MG of a communication management equipment SG according to the invention may be produced in the form of electronic circuits, software (or electronic data processing) modules, or a combination of circuits and software.

The invention also offers a method of calculating the propagation time of a reference signal between a communications management equipment SG of a communications network (where appropriate a random access network) and user equipments UE attached to that management equipment SG, the management equipment SG and the user equipments UE each having an internal time reference defined relative to the time reference of a GNSS network CS and supplied by a GNSS receiver.

This method may in particular be implemented with the aid of the communications management equipment SG and the communication terminals UE described hereinabove. The principal and optional functions and subfunctions of the steps of this method being substantially identical to those of the various means constituting the communications management equipment SG and the communication terminals UE, there will be summarized hereinafter only the steps implementing the principal functions of the method according to the invention.

That method consists in:
sending to the terminals UE, by means of the equipment SG and on at least one (common or dedicated) signaling channel, a reference signal and an associated message including information representative of the time of sending the reference signal relative to the time reference of the GNSS network CS,
then, when a terminal UE receives a reference signal and the associated message, time stamping the reception of the message so that the terminal UE can determine a time difference between the time of sending and the time of receiving the message and deduce therefrom the propagation time of the associated reference signal.

Thanks to the invention, it is not necessary to modify the communication standards. Furthermore, the calculations effected by the terminals are simpler than those of the prior art relying on the use of the ephemeredes, which no longer need to be broadcast, thereby freeing up resources. Moreover, because the ephemeredes are no longer broadcast, the terminals no longer need to listen to the information broadcasting service before initiating a network access request. Also, sending by the terminals being synchronized with each other, this means that in the case of TDMA type networks the guard time between access slots may be reduced and that in the case of CDMA type networks interference may be significantly reduced and transmission capacity thereby increased, at the same time as authorizing a reduction of the necessary sending power, because the CDMA codes are synchronized and therefore mutually orthogonal.

The invention is not limited to the communication terminal, communications management equipment and propagation times calculation method described hereinabove by way of example only, but encompasses all variants that the person skilled in the art might envisage within the scope of the following claims.

Thus there has been described hereinabove a communications management equipment taking the form of a satellite base station (or gateway), but the communications management equipment may equally take the form of a base station, such as a Node B or a BTS coupled to a GNSS receiver. Moreover, the preceding description refers to a random access satellite communications network. However, the invention is not limited to this type of random access network alone. It concerns all random access communications networks (FDMA, CDMA, TDMA) in which there exists a spread (or divergence) of the times of propagation of signals between a communications management equipment and communication terminals, and in particular communications networks including radio repeaters or relays, where applicable of satellite type, connected to a base station, as well as optical networks using optical fibers with or without relays.

Nor is the invention limited to random access networks alone. In fact it concerns, as previously indicated, all communications networks, cable or otherwise, in which it is not possible to know accurately the propagation time of a signal. Consequently, the invention is not limited to locking the time of sending, whether this means locking with a view to accessing the network for the first time, as described hereinabove, or locking with a view to enabling subsequent access to the network, in particular in the case of CDMA 2000 and IS95 networks. It may equally concern the accurate adaptation of timers via messages including a sending date and time, used in particular in IP communications and in certain mobile or cellular telephones. It may equally concern servers, repeaters and routers in which data is momentarily blocked, for example with a view to analysis or in the case of a traffic overload. Accordingly, the invention can reduce interference, in particular in the case of the use of dedicated signaling channels, and/or optimize the infrastructure of the receivers.

1. Method of calculating the propagation time of a reference signal between a communications management equipment (SG) of a communications network and communication terminals (UE) attached to said equipment (SG), said equipment (SG) and said terminals (UE) each having an internal time reference defined relative to a time reference of a satellite positioning network (CS) and supplied by a positioning receiver (RG1, RG2), characterized in that it consists in sending to said terminals (UE), by means of said equipment (SG) and on at least one signaling channel, a reference signal and an associated message including information representative of the time of sending of said reference signal relative to said time reference, then, in the event of reception of said reference signal and said message by one of said terminals (UE), time stamping the reception of said message so that said terminal (UE) can determine a time difference between said time of sending and said time of receiving the message and deduce therefrom the propagation time of the associated reference signal.

2. Method according to claim 1, characterized in that, said reference signal defining a reference for the temporal synchronization of said terminals (UE) relative to a model defining authorized access slots to said network, there is deduced from said propagation time, at the level of a terminal (UE), a time difference representative of the round trip propagation time of a signal between said equipment (SG) and the terminal concerned (UE), then this shift is applied to said model so as to lock the sending system (CE) of said terminal (UE) to said shifted model with a view to the transmission of a request for access to the network to said communications management equipment (SG) in one of said authorized access slots.

3. Method according to either claim 1, characterized in that said reference signal and said associated message are transmitted on the same signaling channel.

4. Method according to claim 1, characterized in that said reference signal and said associated message are transmitted on different signaling channels.

5. Communications management equipment (SG) for a communications network, comprising management means (MG) adapted to generate reference signals to be transmitted, on a signaling channel, to communication terminals (UE) attached to it, and having, like each of said terminals (UE), an internal time reference defined relative to a time reference of a satellite positioning network (CS) and supplied by a positioning receiver (RG1), characterized in that said management means (MG) are further adapted to generate a message including information representative of the time of sending a reference signal relative to said time reference with a view to its transmission to said terminals (UE) on a signaling channel.

6. Communications management equipment according to claim 5, characterized in that said reference signal and said associated message are transmitted on the same signaling channel.

7. Communications management equipment according to claim 5, characterized in that said reference signal and said associated message are transmitted on different signaling channels.

8. Communications management equipment according to claim 5, characterized in that it comprises said positioning receiver (RG1).

9. Communications management equipment according to claim 5, characterized in that it is coupled to said positioning receiver (RG1).

10. Communication terminal (UE) for a communications network including at least one communications management equipment (SG) according to claim 5, said terminal (UE) including receiving means (RG2) adapted to define, from signals coming from a satellite positioning network (CS), an internal time reference relative to a time reference of said positioning network (CS), characterized in that it comprises processing means (PM) adapted, on reception of a reference signal and an associated message including information representative of the time of sending said reference signal relative to said time reference transmitted by the communications management equipment (SG) to which it is attached on at least one signaling channel, to time stamp the reception of said message and then to determine a time difference between said time of sending and said time of receiving the message so as to deduce from this time difference the propagation time of the reference signal associated with said message.

11. Communication terminal according to claim 10, characterized in that said reference signal defining a reference for its time synchronization relative to a model defining authorized access slots to said network, said processing means (PM) are adapted to deduce from said propagation time a time shift representative of the round trip propagation time of a signal between said equipment (SG) and said terminal (UE) and then to apply that shift to said model, and in that it comprises a sending system (CE) adapted to synchronize to said shifted model to transmit a network access request to said communications management equipment (SG) in one of said authorized access slots.

12. Use of the calculation method, according to claim 1 in a random access communications network chosen in a group comprising FDMA, TDMA and CDMA networks.

13. Use of the calculation method, according to claim 1 for the temporal adaptation of timing means.

14. Use of the communications management equipment (SG) according to claim 5 in a random access communications network chosen in a group comprising FDMA, TDMA, and CDMA networks.

15. Use of the communication terminal (UE) according to claim 10 in a random access communications network chosen in a group comprising FDMA, TDMA, and CDMA networks.

16. Use of the communications management equipment (SG) according to claim 5 for the temporal adaptation of timing means.

17. Use of the communication terminal (UE) according to claim 10 for the temporal adaptation of timing means.
